(19) United States
(12) Patent Application Publication
(10) Pub. No.: US 2013/0258063 A1
(43) Pub. Date: Oct. 3, 2013

(54) COMPUTING DEVICE AND METHOD FOR AUTOMATICALLY INSPECTING QUALITY OF PRODUCTS ON AN AUTOMATIC PRODUCTION LINE

(71) Applicants: HOU-HSIEN LEE, New Taipei (TW); CHANG-JUNG LEE, New Taipei (TW); CHIH-PING LO, New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 13/684,192

(22) Filed: Nov. 22, 2012

(30) Foreign Application Priority Data
Apr. 2, 2012 (TW) 101111647

(51) Int. Cl. H04N 7/18

(52) U.S. Cl. CPC H04N 7/181
USPC 348/47

(57) ABSTRACT

In a method for automatically inspecting quality of products on an automatic production line using a computing device, at least two depth-sensing cameras are positioned in a product inspection area of the automatic production line, and capture one or more 3D product images of a product passing through the product inspection area and obtains X-Y-Z coordinates data of the product. The method calculates a product difference between each of the 3D product images and 3D sample images stored in sample a database, and drives a product selection device of the automatic production line to select a faulty product from the product inspection area if the product difference is greater than the predefined tolerance. The product selection device transfers the faulty product to a faulty product depository of the automatic production line.

### BACKGROUND

1. Technical Field

The embodiments of the present disclosure relate to aircraft control systems and methods, and more particularly to a computing device and method for automatically inspecting quality of products on an automatic production line.

2. Description of Related Art

Quality control in automatic production lines is demanding as a given manufacturer can manufacture a wide variety of finished products in a short period of time. However, maintaining quality control across the different production lines can be challenging. For example, in the production of products from raw materials and intermediate components, it is an ongoing challenge to ensure quality of finished products on the automatic production lines. Many attempts have been made to improve of the quality of the finished products manually. These processes may continue to operate for hours, yielding products that may not comply with specifications, and sometimes resulting in enormous amounts of time wasted. Therefore, there is a need to provide an improved quality inspecting system and method for the automatic production lines.

### BRIEF DESCRIPTION OF THE DRAWINGS

FIG. 1 is a block diagram of one embodiment of a computing device for automatically inspecting quality of products on an automatic production line.

FIG. 2 is a block diagram of one embodiment of the computing device installed on the automatic production line of FIG. 1.

FIG. 3 is a flowchart of one embodiment of a method for automatically inspecting quality of products of the automatic production line using the computing device of FIG. 1.

FIG. 4 is a schematic diagram illustrating one example of creating a 3D sample database.

FIG. 5 is a schematic diagram illustrating one example of filtrating faulty products from the automatic production line.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

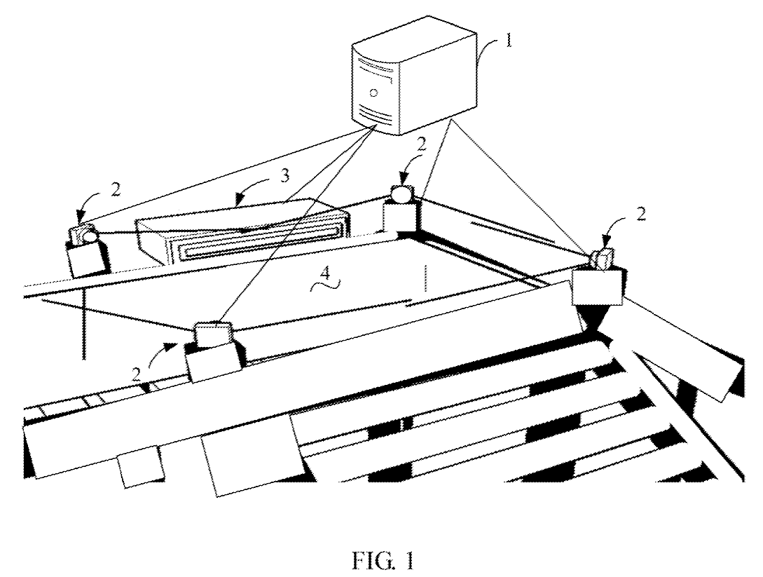

FIG. 1 is a block diagram of one embodiment of a computing device 1 for automatically inspecting quality of products on an automatic production line 4. In the embodiment, the computing device 1 may be a host computer, a workstation computer, or a server computer. The computing device 1 connects to a plurality of depth-sensing cameras 2 through a local area network (LAN) or other suitable networks. Each of the depth-sensing cameras 2 is positioned in both left and right sides of a conveyor belt of the automatic production line 4. The computing device 1 is further electronically connected to a product selection device 3 through a wired-electrical connection. The product selection device 3 is placed on a side of the automatic production line 4.

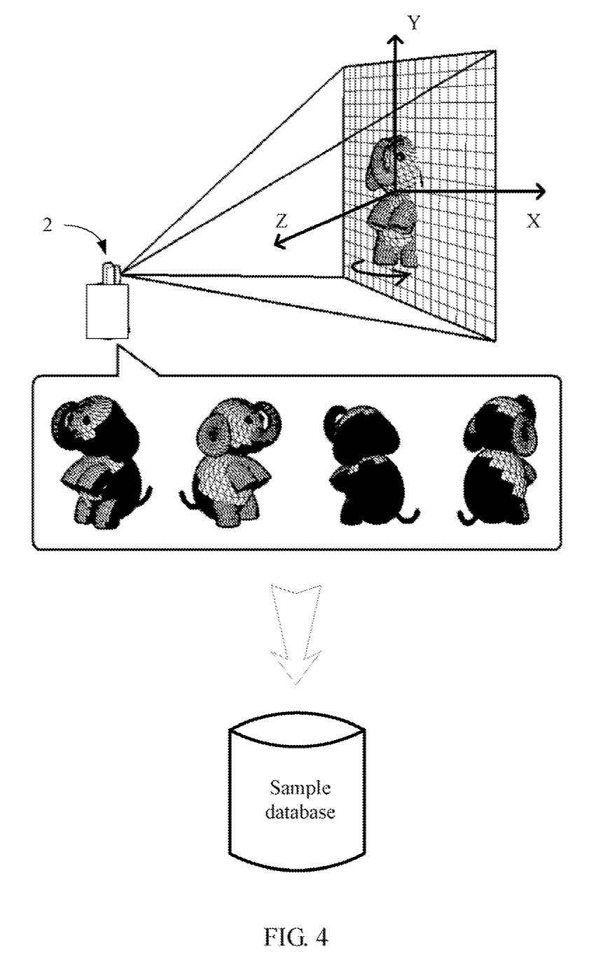

In one embodiment, each of the depth-sensing cameras 2 is a time of flight (TOF) camera device having a 3D image capturing functionality, and can capture one or more 3D images of the product (hereinafter “3D product image”) that is passing through a product inspection area of the automatic production line 4. Referring to FIG. 4, each of the 3D product images include X-coordinate data and Y-coordinate data of the product. Each of the depth-sensing cameras 2 can sense a Z-coordinate distance between a camera lens of the depth-sensing camera 11 and the product. In the embodiment, the product is illuminated by a short light, and each of the depth-sensing cameras 2 measures a time taken from when the light hits the product until the reflected light reaches the depth-sensing camera 11 (hereafter called “the reflected time”). This reflected time is directly proportional to the Z-coordinate distance between the camera lens and the product. Therefore, each of the depth-sensing camera 11 senses the Z-coordinate distance between the camera lens and the product according to a pulse time of the short light illuminating at the product and the reflected time of the reflected light from the product.

The product selection device 3 is placed on a side of the automatic production line 4, and is used to select the product from the product inspection area of the automatic production line 4 when the product is a faulty product, and transfers the faulty product to a faulty product depository of the automatic production line 4.

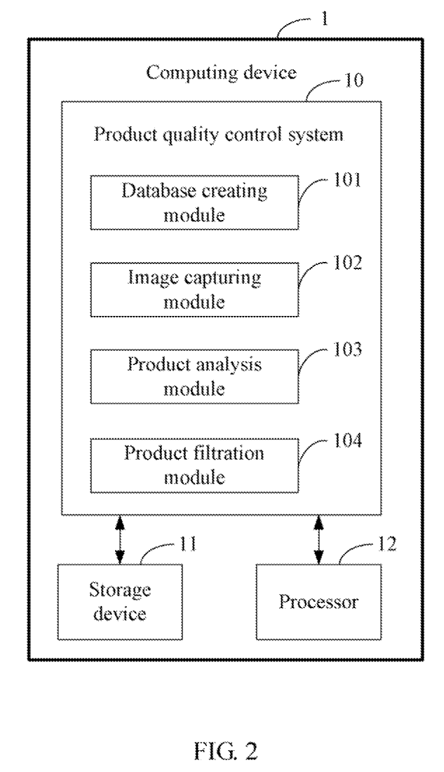

FIG. 2 is a block diagram of one embodiment of the computing device 1 of the automatic production line 4 of FIG. 1. In the embodiment, the computing device 1 includes a product quality control system 10, a storage device 11, and at least one processor 12. In one embodiment, the product quality control system 10 may include computerized instructions in the form of one or more programs that are stored in the storage device 11 and executed by the at least one processor 12. It should be understood that FIG. 2 illustrates only one example of the computing device 1 that may include more or fewer components than illustrated, or have a different configuration of the various components in other embodiments.

In one embodiment, the storage device 11 may be an internal storage system, such as a random access memory (RAM) for the temporary storage of information, and/or a read only memory (ROM) for the permanent storage of information. In some embodiments, the storage device 11 may be an external storage system, such as an external hard disk, a storage card, or a data storage medium. The processor 12 may be a central processing unit including a math co-processor, for example.

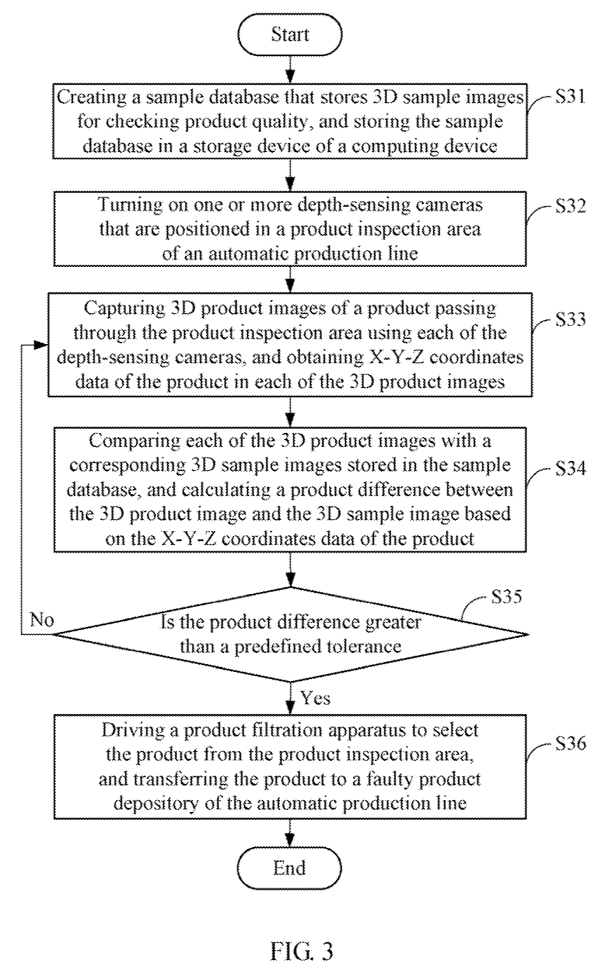

In one embodiment, the product quality control system 10 may include a 3D sample creating module 101, an image capturing module 102, a product analysis module 103, and a product filtration module 104. The modules 101-104 may comprise computerized codes in the form of one or more programs that are stored in the storage device 11 and executed by the processor 12 to provide functions for implementing the modules. Detailed descriptions of each module will be given with reference to FIG. 3 as described in the following paragraphs.

FIG. 3 is a flowchart of one embodiment of a method for automatically inspecting quality of products of the automatic production line 4 using the computing device 1 of FIG. 1. In the embodiment, the method can select faulty products from a product inspection area of the automatic production line 4, and transfers the faulty products to a faulty product depository of the automatic production line 4. Depending on the embodiment, additional blocks may be added, others removed, and the ordering of the blocks may be changed.

In step S31, the 3D sample creating module 101 creates a sample database that stores a plurality of 3D sample images of a standard product. The 3D images of the standard product are used as a comparison to check quality of products produced by the automatic production line 4. The sample database is stored in the storage device 11 of the computing device 1.

FIG. 4 is a schematic diagram illustrating one example of creating the 3D sample database. In one embodiment, the 3D sample images of the standard product may be pre-captured using the depth-sensing camera 2, and may include different visual sides images of the standard product, such as a frontal side image, a rear side image, a left side image, a right side image, an upper side image, and a bottom side image. The sample database is created according to the various 3D sample images, and is stored in the storage device 11 of the computing device 1.

In step S32, the image capturing module 102 controls each of the depth-sensing cameras 2 to capture one or more 3D product images of a product passing through the product inspection area. In one embodiment, at least two depth-sensing cameras 2 are positioned in both left and right sides of a conveyor belt in the product inspection area of the automatic production line 4.

In step S33, the image capturing module 102 captures one or more 3D product images of a product passing through the product inspection area using each of the depth-sensing cameras 2, and obtains X-Y-Z coordinates data of the product in each of the 3D product images. Referring to FIG. 4, the X-Y-Z coordinates data includes X-coordinate data and Y-coordinate data of the product, and a Z-coordinate distance between the depth-sensing camera 2 and the product passing through the product inspection area of the automatic production line 4.

In step S34, the product analysis module 103 compares each of the 3D product images with the 3D sample images stored in the sample database of the storage device 11, and calculates a product difference between each of the 3D product images and a corresponding 3D sample image based on the X-Y-Z coordinates data of the product in the 3D product image. In the embodiment, the product difference is defined as a similarity coefficient between the produced product and the standard product, for example, similarity coefficient between the produced product and the standard product may be ninety percent. If the 3D product image is a frontal side image of the product, the product analysis module 103 compares the frontal side image of the product with a frontal side image of the standard product of the sample database. If the 3D product image is a rear side image of the product, the product analysis module 103 compares the rear side image of the product with a rear side image of the standard product of the sample database.

In step S35, the product analysis module 103 determines whether the product difference is greater than a predefined tolerance. For example, the tolerance may be predefined as ten percent of the product difference between the produced product and the standard product. If the product difference is greater than the predefined tolerance, the product analysis module 103 determines that the product is a faulty product, and step S36 is implemented. If the product difference is not greater than the predefined tolerance, the product analysis module 103 determines that the product is a qualified product, and step S33 is repeated.

In step S36, the product filtration module 104 drives the product selection device 3 to select the faulty product from the product inspection area, and transfers the faulty product to a faulty product depository of the automatic production line 4. In the embodiment, the product filtration module 104 generates a product selection command to drive the product selection device 3 to select the faulty product from the product inspection area, and the product selection device 3 transfers the faulty product to the faulty product depository of the automatic production line 4.

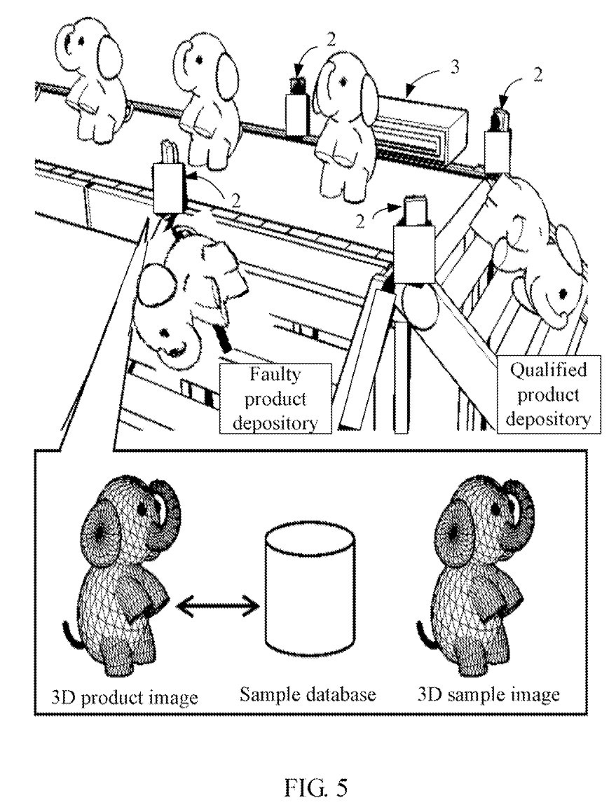

FIG. 5 is a schematic diagram illustrating one example of filtrating faulty products from the automatic production line 4. In one embodiment, the automatic production line 4 is equipped with the faulty product depository for depositing faulty products from the automatic production line 4, and a qualified product depository for depositing faulty products from the automatic production line 4. The product selection device 3 selects a product from the product inspection area when the product is determined as a faulty product, and transfers the faulty product to the faulty product depository. The product selection device 3 further selects a product from the product inspection area when the product is determined as a qualified product, and transfers the qualified product to the qualified product depository.

All of the processes described above may be embodied in, and fully automated via, functional code modules executed by one or more general purpose processors of the computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device electronically connected to a plurality of depth-sensing cameras positioned in a product inspection area of an automatic production line, the computing device comprising:
a storage device;
at least one processor; and
one or more programs stored in the storage device and executed by the at least one processor, the one or more programs comprising:
an image capturing module that controls the plurality of depth-sensing to capture one or more 3D product images of a product passing through the product inspection area, and obtains X-Y-Z coordinates data of the product in each of the 3D product images;
a product analysis module that compares each of the 3D product images with 3D sample images stored in a sample database of the storage device, calculates a product difference between each of the 3D product images and a corresponding 3D sample image based on the X-Y-Z coordinates data of the product in the 3D product image, and determines whether the product difference is greater than a predefined tolerance; and
a product filtration module that drives a product selection device of the automatic production line to select the product from the product inspection area as a faulty product if the product difference is greater than the predefined tolerance, and transfers the faulty product to a faulty product depository of the automatic production line using the product selection device.

2. The computing device according to claim 1, wherein the one or more programs further comprises a 3D sample creating module that creates the sample database according to different visual sides images of a standard product, the sides images comprising a frontal side image, a rear side image, a left side image, a right side image, an upper side image, and a bottom side image of the standard product.

3. The computing device according to claim 1, wherein each of the depth-sensing cameras is a time of flight (TOF) camera device having a 3D image capturing functionality, and senses a Z-coordinate distance between the depth-sensing camera and the product.

4. The computing device according to claim 3, wherein the X-Y-Z coordinates data comprise X-coordinate data and Y-coordinate data of the product, and the Z-coordinate distance between the depth-sensing camera and the product.

5. The computing device according to claim 1, wherein the depth-sensing cameras are installed on both left and right sides of a conveyor belt of the automatic production line.

6. The computing device according to claim 1, wherein the product analysis module determines that the product is a qualified product if the product difference is not greater than the predefined tolerance, and the product filtration module drives the product selection device to select the qualified product from the product inspection area and transfers the qualified product to a qualified product depository of the automatic production line.

7. A method for automatically inspecting quality of products on an automatic production line using a computing device, the method comprising:
turning on a plurality of depth-sensing cameras that are positioned in a product inspection area of the automatic production line;
capturing one or more 3D product images of a product passing through the product inspection area using each of the depth-sensing cameras, and obtaining X-Y-Z coordinates data of the product in each of the 3D product images;
comparing each of the 3D product images with 3D sample images stored in a sample database of a storage device of the computing device, and calculating a product difference between each of the 3D product images and a corresponding 3D sample image based on the X-Y-Z coordinates data of the product in the 3D product image;
determining whether the product difference is greater than a predefined tolerance; and
driving a product selection device of the automatic production line to select the product from the product inspection area as a faulty product if the product difference is greater than the predefined tolerance; and
transferring the faulty product to a faulty product depository of the automatic production line using the product selection device.

8. The method according to claim 7, further comprising:
creating the sample database according to different visual sides images of a standard product, the sides images comprising a frontal side image, a rear side image, a left side image, a right side image, an upper side image, and a bottom side image of the standard product.

9. The method according to claim 7, wherein each of the depth-sensing cameras is a time of flight (TOF) camera device having a 3D image capturing functionality, and senses a Z-coordinate distance between the depth-sensing camera and the product.

10. The method according to claim 9, wherein the X-Y-Z coordinates data comprise X-coordinate data and Y-coordinate data of the product, and the Z-coordinate distance between the depth-sensing camera and the product.

11. The method according to claim 7, wherein the depth-sensing cameras are positioned in both left and right sides of a conveyor belt of the automatic production line.

12. The method according to claim 7, further comprising:
determining that the product is a qualified product if the product difference is not greater than the predefined tolerance;
driving the product selection device to select the qualified product from the product inspection area; and
transferring the qualified product to a qualified product depository of the automatic production line.

13. A non-transitory computer-readable storage medium having stored thereon instructions that, when executed by at least one processor of a computing device, cause the computing device to perform a method for automatically inspecting quality of products on an automatic production line, the method comprising:
turning on a plurality of depth-sensing cameras that are positioned in a product inspection area of the automatic production line;
capturing one or more 3D product images of a product passing through the product inspection area using each of the depth-sensing cameras, and obtaining X-Y-Z coordinates data of the product in each of the 3D product images;
comparing each of the 3D product images with 3D sample images stored in a sample database of a storage device of the computing device, and calculating a product difference between each of the 3D product images and a corresponding 3D sample image based on the X-Y-Z coordinates data of the product in the 3D product image;
determining whether the product difference is greater than a predefined tolerance; and
driving a product selection device of the automatic production line to select the product from the product inspection area as a faulty product if the product difference is greater than the predefined tolerance; and
transferring the faulty product to a faulty product depository of the automatic production line using the product selection device.

14. The storage medium according to claim 13, wherein the method further comprises:
creating the sample database according to different visual sides images of a standard product, the sides images comprising a frontal side image, a rear side image, a left side image, a right side image, an upper side image, and a bottom side image of the standard product.

15. The storage medium according to claim 13, wherein each of the depth-sensing cameras is a time of flight (TOF) camera device having a 3D image capturing functionality, and senses a Z-coordinate distance between the depth-sensing camera and the product.

16. The storage medium according to claim 15, wherein the X-Y-Z coordinates data comprise X-coordinate data and Y-coordinate data of the product, and the Z-coordinate distance between the depth-sensing camera and the product.

17. The storage medium according to claim 13, wherein the depth-sensing cameras are installed on left and right sides of a conveyor belt of the automatic production line.

18. The storage medium according to claim 13, wherein the method further comprises:
determining that the product is a qualified product if the product difference is not greater than the predefined tolerance;
driving the product selection device to select the qualified product from the product inspection area; and
transferring the qualified product to a qualified product depository of the automatic production line.
